(19) United States
(12) Patent Application Publication
(10) Pub. No.: US 2011/0083746 A1
(43) Pub. Date: Apr. 14, 2011

(54) SMART VALVE UTILIZING A FORCE SENSOR

(75) Inventor: Loc Gia Hoang, Houston, TX (US)

(73) Assignee: CAMERON INTERNATIONAL CORPORATION, Houston, TX (US)

(21) Appl. No.: 12/577,142

(22) Filed: Oct. 9, 2009

(51) Int. Cl. F15D 1/00; F16K 37/00; F16K 17/00

(52) U.S. Cl. 137/1; 137/557; 137/511

(57) ABSTRACT

A valve, in certain embodiments, includes a body having a flow path, a stem, a flow element coupled to the stem, wherein the flow element interfaces with the flow path to regulate flow of a fluid through the flow path, and a force sensor coupled to the stem and configured to indicate an amount of force exerted on the stem.

### FIELD OF INVENTION

The present invention relates to regulation and monitoring of fluid flow. More particularly, the present invention relates to a smart valve for monitoring valve performance and for measuring the pressure of a process fluid flowing through the smart valve.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

The use of valves to manage and transmit materials is ubiquitous. Valves generally include an open position that enables fluid flow and a closed position that reduces or completely shuts off the fluid flow. Monitoring of conditions (e.g., flow and pressure) of the fluid flowing through the valve is generally desirable. In addition, monitoring of performance of the valve is also generally desirable. In particular, during the life of the valve, its condition and performance may typically degrade. Further, the valve may foul due to adverse process conditions, for example. Consequently, the valve may be repaired or replaced.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a front view of a smart valve which may incorporate a force sensor in accordance with an embodiment of the present invention;

FIG. 2 is a cross-section of the smart valve taken along line 1-1 of FIG. 1 that depicts the smart valve in a closed position in accordance with an embodiment of the present invention;

FIG. 3 is a cross-section of the smart valve taken along line 1-1 of FIG. 1 that depicts the smart valve in an open position in accordance with an embodiment of the present invention;

FIG. 4 is a cross-section of the smart valve taken along line 1-1 of FIG. 1 that depicts the smart valve transitioning from a closed position to an open position in accordance with an embodiment of the present invention;

FIG. 5 is a flow chart of a method for determining a pressure of a process fluid using the smart valve in accordance with an embodiment of the present invention; and

FIG. 6 is a flow chart of a method for determining the performance or other condition of the smart valve in accordance with an embodiment of the present invention.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The disclosed embodiments include a smart valve, which includes a force sensor (e.g., load sensor, load cell, strain gauge, and so forth) to monitor the force (or pressure) exerted on the stem of a valve member. Incorporation of the force sensor facilitates monitoring of valve performance throughout the life of the valve, as well as monitoring of the flow line (e.g., process) pressure. In addition, the flow line pressure (i.e., the pressure of the process fluid being regulated by the valve) may be monitored both when the valve is in a shut-in condition (e.g., no fluid flow through the valve flow path) and when the valve is in an open position. In other embodiments, the flow line pressure may otherwise be monitored via a pressure gauge, pressure transducer, or other pressure element installed directly into the flow path of the valve. A benefit of using the force sensor to monitor flow pressure is the elimination of a possible leak path associated with an instrument tap (i.e., with a pressure gauge) installed directly in the flow line, for example.

Valve performance may be evaluated by the amount of supplied pressure needed to actuate the valve, or by disassembling the valve to inspect internal parts, for example. In contrast, incorporation of the force sensor in the valve will generally provide for improved monitoring of the valve performance without disassembly of the valve. The sensed force information may be employed to alter the maintenance program of the valve, for example. In addition, the force sensor may be employed to monitor the flow line pressure (i.e., the pressure exerted by the process fluid in the flow path of the valve) via the pressure acting on the valve stem's cross sectional area. Further, as discussed below, incorporation of a displacement transducer in the valve to measure stem movement may provide additional information with regard to valve performance. The disclosed embodiments may be applied to existing designs with relatively minor modification in certain applications. Examples of the smart valves disclosed herein may include flow valves, gate valves, butterfly valves, plug valves, ball valves, needle valves, and so on. Whatever the type of valve, it is generally beneficial to monitor the performance of the smart valve, as well as to obtain information about the fluid the smart valve is regulating.

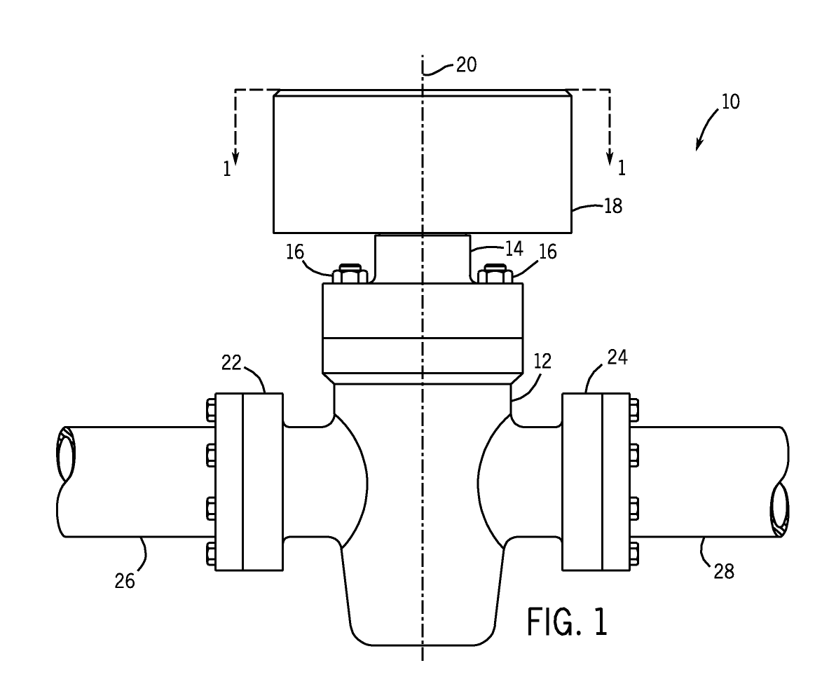

FIG. 1 is a front view of a smart valve 10 which may incorporate a force sensor in accordance with an embodiment of the present invention. The smart valve 10 may include a valve body 12 coupled to a valve bonnet 14 via one or more bolts 16. The smart valve 10 may also include an actuator assembly 18 that, as described below, may be used to move a valve stem of the smart valve 10 axially along a central axis 20 of the smart valve 10 to actuate the smart valve 10 between open and closed positions. The actuator assembly 18 may be operated by a human operator (e.g., using an override tool) or may be automatically operated by a hydraulic or electric drive system.

The smart valve 10 also includes an inlet passage 22 and an outlet passage 24 to provide connection to piping or other components. For example, the smart valve 10 may be placed between an upstream pipe 26 transporting a process fluid from a source and a downstream pipe 28 transporting the process fluid to downstream equipment. In such an embodiment, the smart valve 10 may be used in an on/off manner to allow or block flow from the upstream pipe 26 through the smart valve 10 and into the downstream pipe 28. In other embodiments, the smart valve 10 may be used to regulate (e.g., choke) flow from the upstream pipe 26 into the downstream pipe 28.

The materials of the smart valve 10 may vary considerably, depending on the specific applications, for example. Valve materials may include carbon steel, stainless steel, low alloy steel, nickel plated materials, nickel alloys (e.g., iconel, monel, and the like), Teflon inserts, and so forth. Sealing and gasketing materials may include Teflon, PTFE, elastomers, metals, and so forth. The pressure and temperature ratings of the smart valve 10 may also vary considerably, depending upon the particular application. Moreover, such ratings are not intended to limit the present techniques, which may be used for any flow line pressure. Temperature ratings may be for very low temperatures, ambient temperatures, very high temperatures, and so forth.

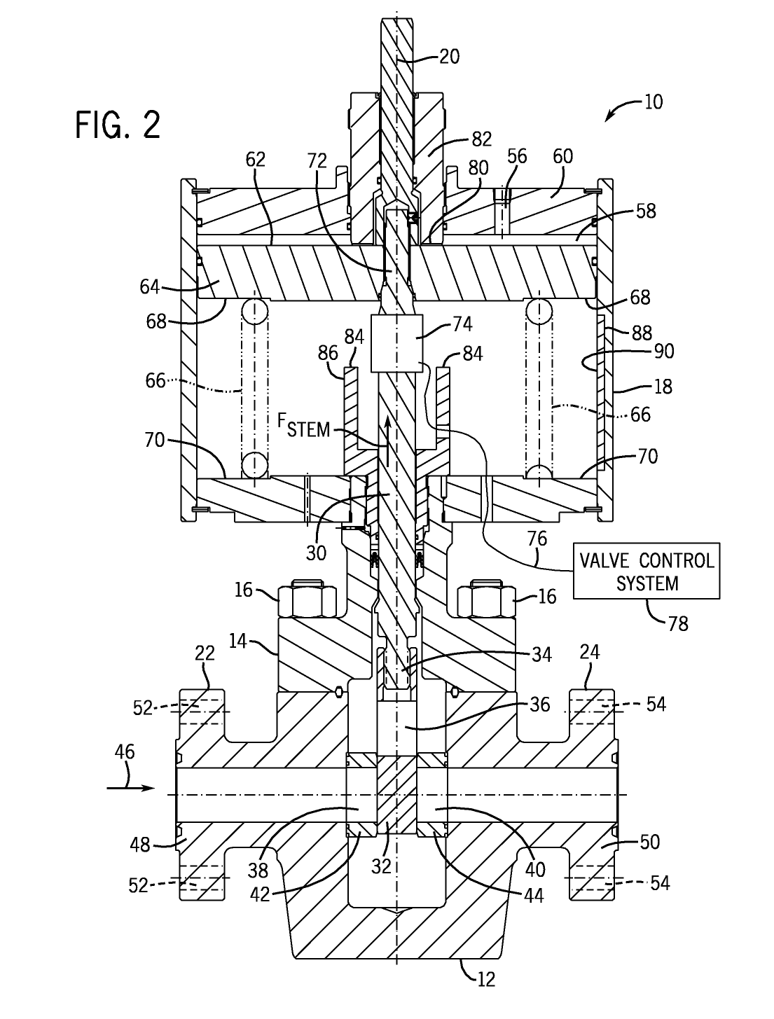

FIG. 2 is a cross-section of the smart valve 10 taken along line 1-1 of FIG. 1 that depicts the smart valve 10 in a closed position in accordance with an embodiment of the present invention. The smart valve 10 includes a valve stem 30 with a valve gate 32 attached to a lower end 34 of the valve stem 30. In certain embodiments, the valve gate 32 may be attached to the lower end 34 of the valve stem 30 via threading. However, in other embodiments, the valve gate 32 may be attached to the lower end 34 of the valve steam 30 using other connection methods, such as T-slots, pins, lift nuts, and so forth.

The valve gate 32 may include a port 36 that allows process fluid flow through the valve body 12 when the valve gate 32 is moved to an open position. In particular, the port 36 is an opening through the valve gate 32 such that, when the valve gate 32 is in an open position, the port 36 generally aligns with openings 38, 40 within an inlet seat 42 and an outlet seat 44, respectively, of the valve body 12. By moving the valve gate 32 axially along the central axis 20 of the smart valve 10 such that the port 36 is aligned with the openings 38, 40 in the inlet seat 42 and the outlet seat 44, the smart valve 10 may be opened and the process fluid may be allowed to flow through the valve body 12 of the smart valve 10. Similarly, by moving the valve gate 32 axially along the central axis 20 of the smart valve 10 such that the port 34 is not aligned with the openings 38, 40 in the inlet seat 42 and the outlet seat 44, the smart valve 10 may be closed. It should be appreciated that the smart valve 10 may be bi-directional, and the terms “inlet” and “outlet” are used for ease of reference and do not describe any specific directional limitation of the smart valve 10. For example, the seats 42, 44 may be either inlet or outlet seats, respectively. It should also be appreciated that the location of the port 36 on the valve gate 32 is relative. In general, the port 36 shown in FIGS. 2 through 4 is for a fail-close valve. However, in other embodiments, the port 36 may be aligned with the openings 38, 40 to be a fail-open valve.

The flow path of the smart valve 10 is depicted by arrow 46. Inlet and outlet valve connections 48, 50 may be used to couple the valve body 12 of the smart valve 10 to process conduits or process piping. In the illustrated embodiment, the inlet and outlet valve connections 48, 50 include flanges having inlet and outlet bolt holes 52, 54 for connecting to the process conduits or process piping (e.g., the upstream and downstream pipe 26, 28 illustrated in FIG. 1). However, in other embodiments, the inlet and outlet valve connections 48, 50 may be screw connections, welded connections, and so forth.

As described above with respect to FIG. 1, the smart valve 10 may include an actuator assembly 18. An actuator pressure control inlet 56 may enable monitoring and control of the actuator pressure within a pressurized cavity 58 within the actuator assembly 18. In particular, in certain embodiments, a pressurized fluid (e.g., air, oil, water, other hydraulic fluids, and so forth) may be allowed to flow into and out of the pressurized cavity 58 through the actuator pressure control inlet 56. A cylinder head 60 of the actuator assembly 18 may ensure that the pressure in the pressurized cavity 58 is retained. The pressurized fluid within the pressurized cavity 58 may exert the actuator pressure, which may be used to adjust or maintain the position (e.g., open or closed) of the valve stem 30 of the smart valve 10. In particular, the actuator assembly 18 may operate much like a piston, wherein the actuator pressure within the pressurized cavity 58 exerts a downward force onto an upper surface 62 of a piston head 64 within the actuator assembly 18.

In general, this downward force may be resisted by actuator springs 66, which may generally extend from a lower surface 68 of the piston head 64 to a lower inner wall 70 of the actuator assembly 18. In certain embodiments, the actuator springs 66 may be held in place such that the actuator springs 66 are only allowed to move axially. In other words, radial and tangential movement of the actuator springs 66 may be constrained in these respective directions. For example, in certain embodiments, the actuator springs 66 may be held within cylindrical tubes, which also extend from the lower surface 68 of the piston head 64 to the lower inner wall 70 of the actuator assembly 18.

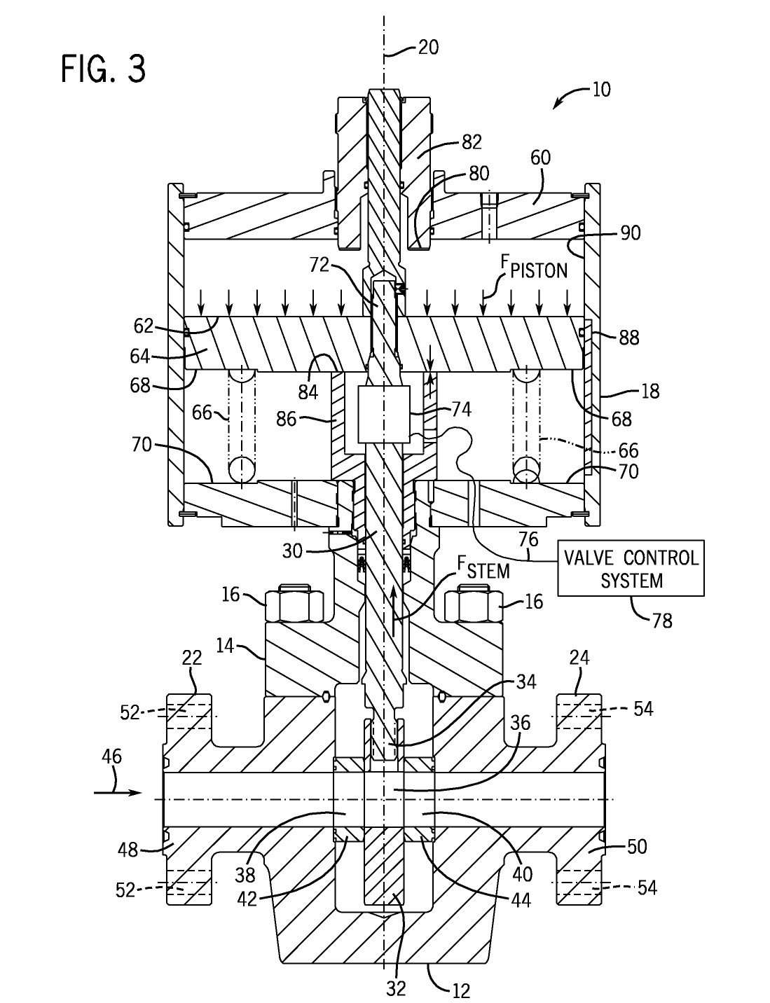

As described above, the actuator pressure within the pressurized cavity 58 may exert a downward force on the upper surface 62 of the piston head 64, which may be resisted by the actuator springs 66, and the flow pressure may act on the valve stem 30 with other minor friction forces. As such, the interaction between the downward force exerted by the actuator pressure within the pressurized cavity 58 and the upward force created by the resisting actuator springs 66 may determine the axial position of the valve stem 30. In particular, an upper end 72 of the valve stem 30 may be attached to the piston head 64. As the downward force created by the actuator pressure within the pressurized cavity 58 overcomes the upward resistive force of the actuator springs 66, the flow bore pressure acting on the valve stem 30, and the friction force between the surface of the valve gate 32 and the seats 42, 44, the piston head 64 causes the valve stem 30 to move downward axially, for instance, into an open position (see FIG. 3). However, as the upward resistive force of the actuator springs 66 overcomes the downward force created by the actuator pressure within the pressurized cavity 58, the piston head 64 allows the valve stem 30 to move upward axially, for instance, into a closed position. The relative upward and downward forces and motion depicted in the illustrated embodiments are merely illustrative and are not intended to be limiting. For example, in other embodiments, the forces and motion may be in any direction where the resistive force from the actuator springs 66 generally counteracts the actuator pressure within the pressurized cavity 58.

As illustrated, the smart valve 10 may include a force sensor 74 (or load sensor) within the actuator assembly 18, which may be a load cell, strain gauge, and so forth. In general, the force sensor 74 may be attached to the valve stem 30 or may be integral with the valve stem 30 and may generate data signals, which are indicative of the amount of force exerted on the valve stem 30. As such, the force sensor 74 may be external to, and isolated from, the flow path 46 of the smart valve 10. In certain embodiments, a data wire 76 may be used to send the data signals indicative of the force exerted on the valve stem 30 from the force sensor 74 to a valve control system 78. The valve control system 78 may include a processor and memory configured to execute programmable logic. For example, the valve control system 78 may be a programmable logic controller (PLC), a distributed control system (DCS), and so forth. In particular, as described in greater detail below, the valve control system 78 may be configured to convert the data signals indicative of the force exerted on the valve stem 30 into correlative pressures of the process fluid flowing through the valve body 12 of the smart valve 10.

Also, in general, the data signals from the force sensor 74 may be used to determine how to adjust the actuator pressure within the pressurized cavity 58 of the actuator assembly 18. In particular, the valve control system 78 may be configured to adjust the amount of pressurized fluid in the pressurized cavity 58 of the actuator assembly 18 based at least in part on the data signals generated by the force sensor 74. For instance, the valve control system 78 may include logic for determining when to increase, decrease, or maintain the amount of pressurized fluid within the pressurized cavity 58. For, example, in certain embodiments, the valve control system 78 may be configured to adjust the amount of the pressurized fluid is in the pressurized cavity 58.

In particular, in certain embodiments, the valve control system 78 may be configured to determine whether to increase, decrease, or maintain the amount of pressurized fluid within the pressurized cavity 58 by using the data signals from the force sensor 74 to calculate the pressure of the process fluid flowing through the valve body 12 of the smart valve 10. By using the force sensor 74 in this manner, the pressure of the process fluid may be determined without using obtrusive, direct measurement techniques, such as pressure gauges, pressure transducers, or other pressure elements installed directly into the flow path 46 of the process fluid.

In general, the pressure of the process fluid within the valve body 12 of the smart valve 10 may be correlative to the stem force Fₛₜₑₘ (e.g., the force experienced from the flow line pressure acting on the valve stem 30). When the smart valve 10 is in the closed position, as illustrated in FIG. 2, the force sensor 74 may generally experience only the stem force Fₛₜₑₘ. One reason for this is that, when the smart valve 10 is in the closed position, there may be a negligible amount of pressurized fluid within the pressurized cavity 58 of the actuator assembly 18, with the upper surface 62 of the piston head 64 abutting a lower face 80 of an adjustment nut 82. The upward resistive force from the actuator springs 66 may react against the lower surface 68 of the piston head 64 and, thus, against the lower face 80 of the adjustment nut 82. However, in other embodiments, the actuator springs 66 may still exert a certain amount of upward resistive force and the valve control system 78 may be configured to adjust accordingly. As such, when the smart valve 10 is in the closed position, the shut-in pressure Pₛₕᵤₜ₋ᵢₙ may be estimated based at least in part on the force Fₛₑₙₛₒᵣ experienced by the force sensor 74. In particular, the shut-in pressure Pₛₕᵤₜ₋ᵢₙ may be estimated by dividing the force Fₛₑₙₛₒᵣ experienced by the force sensor 74 by the cross-sectional area Aₛₜₑₘ of the valve stem 30 using the equation:

Pₛₕᵤₜ₋ᵢₙ=Fₛₑₙₛₒᵣ/Aₛₜₑₘ

As described above, once the actuator pressure is applied by adding pressurized fluid into the pressurized cavity 58 of the actuator assembly 18, the resulting forces on the piston head 64 will cause the valve stem 30 to move downward axially, such that the smart valve 10 is moved toward its open position. FIG. 3 is a cross-section of the smart valve 10 taken along line 1-1 of FIG. 1 that depicts the smart valve 10 in an open position in accordance with an embodiment of the present invention. As illustrated, the actuator pressure caused by the pressurized fluid within the pressurized cavity 58 may exert an axially downward piston force Fₚᵢₛₜₒₙ distributed along the upper surface 62 of the piston head 64. The piston force Fₚᵢₛₜₒₙ will generally be distributed equally across the upper surface 62 of the piston head 64. In general, the resultant summation of the piston force Fₚᵢₛₜₒₙ will be exerted onto the piston head 64 and, in turn, onto the valve stem 30, causing the valve stem 30 to move downward axially toward the open position of the smart valve 10.

As described above, moving the valve stem 30 axially downward causes the valve gate 32 to move axially downward as well. As such, the port 36 within the valve gate 32 will begin aligning with the openings 38, 40 within the inlet seat 42 and the outlet seat 44, respectively. When this happens, the process fluid will begin flowing through the valve body 12 of the smart valve 10 along the flow path 46. At some point, axial movement of the valve stem 30 downward will be impeded by an upper end 84 of a cylindrical stop 86, within which the valve stem 30 moves axially. At this point, the smart valve 10 is in the fully open position and, since the piston force Fₚᵢₛₜₒₙ is fully transferred to the cylindrical stop 86, the pressure of the process fluid P_{fluid} flowing through the smart valve 10 may be estimated based at least in part on the force Fₛₑₙₛₒᵣ experienced by the force sensor 74. In particular, the pressure of the process fluid P_{fluid} flowing through the smart valve 10 may again be estimated by dividing the force Fₛₑₙₛₒᵣ experienced by the force sensor 74 by the cross-sectional area Aₛₜₑₘ of the valve stem 30 using the equation:

P_{fluid}=Fₛₑₙₛₒᵣ/Aₛₜₑₘ

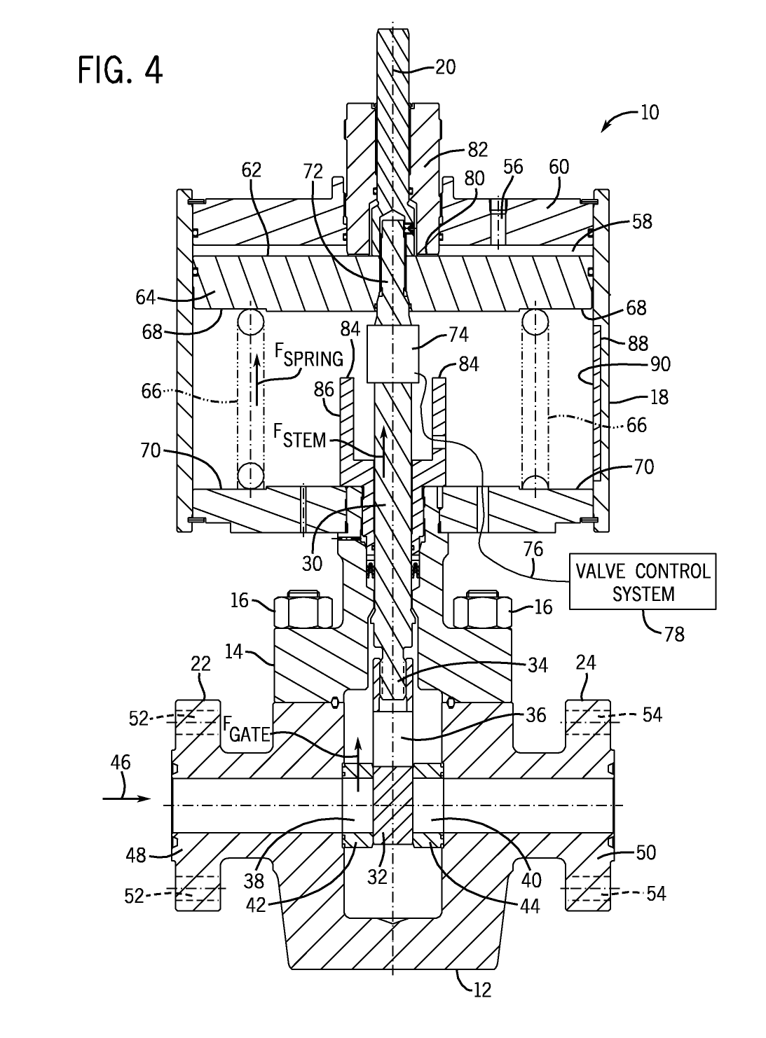

In addition, in certain embodiments, performance characteristics of the smart valve 10 may be estimated using the force Fₛₑₙₛₒᵣ experienced by the force sensor 74. In particular, the valve characteristics of the smart valve 10 may be estimated while the smart valve is moved from a closed position (e.g., FIG. 2) to an open position (e.g., FIG. 3). FIG. 4 is a cross-section of the smart valve taken along line 1-1 of FIG. 1 that depicts the smart valve transitioning from a closed position to an open position in accordance with an embodiment of the present invention. Assuming the smart valve 10 is initially in a closed position, the actuator pressure may gradually be applied by adding pressurized fluid into the pressurized cavity 58 of the actuator assembly 18. As described above, the piston head 64 may begin moving the valve stem 30 axially downward, causing the valve gate 32 to move from a closed to an open position.

When the smart valve 10 is between the closed and open positions, the force Fₛₑₙₛₒᵣ experienced by the force sensor 74 may actually be a summation of multiple forces. More specifically, similar to the closed and open position scenarios, the force sensor 74 will experience the stem force Fₛₜₑₘ. However, in addition, the force sensor 74 will also experience a gate drag force F_{gate} (e.g., the friction force of the closed valve gate 32 acting against the valve seats 42, 44) and a spring force F_{spring} of the actuator springs 66 resisting the axially downward piston force Fₚᵢₛₜₒₙ. When the upstream flow bore (e.g., upstream of the valve gate 32) begins to connect to the downstream flow bore (e.g., downstream of the valve gate 32), the gate drag force F_{gate} will diminish. Therefore, at this point, the force sensor 74 will only experience the stem force Fₛₜₑₘ and minor friction forces experienced at the valve gate 32 and the upper end 72 of the valve stem 30. By monitoring the transition of these forces over time, the amount of the gate drag force F_{gate} may be used as an indicator of the condition of the smart valve 10. In other words, monitoring these forces over time may help determine valve signatures (e.g., indications of operating performance or other conditions) of the smart valve 10.

In certain embodiments, the valve gate drag force F_{gate} may be accounted for by, for instance, subtracting the valve gate drag force F_{gate} from the force Fₛₑₙₛₒᵣ experienced by the force sensor 74. However, in other embodiments, the valve gate drag force F_{gate} may be assumed to be negligible. For example, as described above, when the upstream flow bore (e.g., upstream of the valve gate 32) begins to connect to the downstream flow bore (e.g., downstream of the valve gate 32), the valve gate drag force F_{gate} diminishes to a negligible amount. The valve control system 78 may be configured to account for the valve gate drag force F_{gate} when calculating the pressure P_{fluid} of the process fluid over time.

Optionally, in certain embodiments, a displacement transducer 88 may be installed to measure the axial displacement of the valve stem 30. The axial displacement data generated by the displacement transducer may provide additional information, in conjunction with the force data generated by force sensor 74, to provide additional indications of the valve performance. As illustrated, in certain embodiments, the displacement transducer 88 may be located on an inner wall 90 of the actuator assembly 18 near the piston head 64 such that axial movement of the piston head 64 may be measured as a proxy for the axial displacement of the valve stem 30. However, the displacement transducer 88 may also be located at other positions within the smart valve 10. For example, the displacement transducer 88 may be placed in the actuator assembly 18 to measure the displacement of the piston head 64, the valve stem 30, or even the valve gate 32.

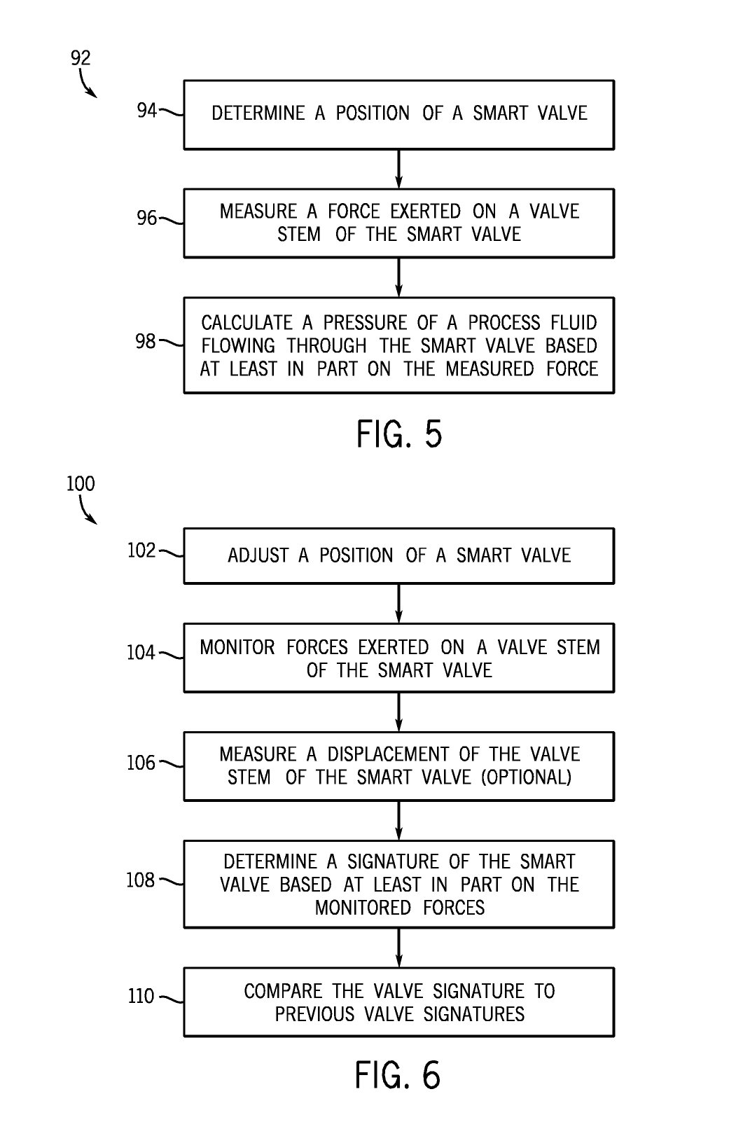

FIG. 5 is a flow chart of a method 92 for determining a pressure of the process fluid using the smart valve 10 in accordance with an embodiment of the present invention. At block 94, a position of the smart valve 10 may be determined. For example, the smart valve 10 may be placed in an open position (e.g., where the port 36 within the valve gate 32 is generally aligned with the openings 38, 40 within the inlet seat 42 and the outlet seat 44). At block 96, a force exerted on the valve stem 30 of the smart valve 10 may be measured. For example, as described above, the force Fₛₜₑₘ exerted on the valve stem 30 may be measured by the force sensor 74. At block 98, a pressure of the process fluid flowing along the flow path 46 within the valve body 12 of the smart valve 10 may be calculated. The process pressure may be correlative with the force Fₛₜₑₘ exerted on the valve stem 30 and may, in certain embodiments, be calculated at least in part by dividing the force Fₛₜₑₘ exerted on the valve stem 30 by the cross-sectional area Aₛₜₑₘ of the valve stem 30. Thus, without entry into the process flow path 46, and thus avoiding potential leakage, the process pressure may be determined using the method 92 of FIG. 5.

FIG. 6 is a flow chart of a method 100 for determining the performance or other condition of the smart valve 10 in accordance with an embodiment of the present invention. At block 102, a position of the smart valve 10 may be adjusted. For example, again, the smart valve 10 may be adjusted to an open position (e.g., where the port 36 within the valve gate 32 is generally aligned with the openings 38, 40 within the inlet seat 42 and the outlet seat 44). During the adjustment of the valve position, at block 104, the forces exerted on the valve stem 30 may be monitored, for instance, via the force sensor 74. Optionally, at block 106, a displacement of the valve stem 30 relative to the flow path 46 may be measured by the displacement transducer 84 positioned within or adjacent to the smart valve 10.

With the data generated by blocks 102, 104 and 106, at block 108, a valve signature (e.g., an indication of operating performance or other condition) may be determined based on the monitored forces. Then, at block 110, this valve signature may be compared to previous valve signatures to determine a change in condition or performance of the smart valve 10 over time. Thus, the valve condition may be determined via the force sensor and optional displacement transducer.

Although discussed herein as applying to the particular type of gate valve illustrated in FIGS. 2 through 4, other types of gate valves, such as those with non-linear flow paths, may also take advantage of the disclosed embodiments. Further, valve types other than gate valves may also benefit from the disclosed embodiments. For example, ball valves may utilize a force sensor and also optionally a displacement transducer. Movement of the stem in the ball valve as well as movement of the ball may be monitored, and the pressure exerted on such elements may be measured. Such data may provide a signature of the valve indicative of operating performance and condition of the valve. Such data may also provide for measurement of the process fluid pressure.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A valve, comprising:
a body having a flow path;
a stem;
a flow element coupled to the stem, wherein the flow element interfaces with the flow path to regulate flow of a fluid through the flow path; and
a force sensor coupled to the stem and configured to indicate an amount of force exerted on the stem.

2. The valve of claim 1, wherein the amount of force indicated by the force sensor is correlative with a pressure of the fluid.

3. The valve of claim 1, wherein the amount of force indicated by the force sensor provides a signature of the valve.

4. The valve of claim 1, wherein the force sensor comprises a load cell.

5. The valve of claim 1, comprising an actuator configured to move the stem to adjust a position of the valve.

6. The valve of claim 5, wherein the actuator comprises a piston configured to act against springs of the actuator to move the stem.

7. The valve of claim 1, comprising a displacement transducer configured to indicate displacement of the stem.

8. The valve of claim 7, wherein the displacement is relative to the flow path.

9. The valve of claim 7, wherein the displacement drives adjustment of the flow element relative to the flow path.

10. The valve of claim 7, wherein the displacement is substantially perpendicular to a direction of fluid flow through the flow path.

11. A system, comprising:
a conduit configured to transmit a fluid;
a valve comprising:
a body having a flow path;
a stem;
a flow element coupled to the stem, wherein the flow element is disposed adjacent the flow path and operates to adjust a position of the valve; and
a force sensor configured to indicate an amount of force exerted on the stem.

12. The system of claim 11, wherein the force exerted on the stem indicated by the force sensor is correlative with a pressure of the fluid.

13. The system of claim 11, wherein the force exerted on the stem indicated by the force sensor provides a signature of the valve over time.

14. The system of claim 11, wherein the force sensor comprises a load cell.

15. The system of claim 11, comprising a displacement transducer configured to measure displacement of the stem or a piston head in an axial direction of the stem.

16. The system of claim 15, wherein the displacement of the stem measured by the displacement transducer provides for a signature of the amount of the force on the stem as a function of the displacement.

17. A method of determining a process pressure, comprising:
determining a position of a valve;
measuring a force exerted on a stem of the valve; and
calculating a process pressure correlative with the force exerted on the stem.

18. The method of claim 17, wherein the force exerted on the stem is measured with a force sensor.

19. The method of claim 17, wherein the process pressure is calculated at least in part by dividing the measured force by the cross-sectional area of the stem.

20. The method of claim 17, comprising measuring displacement of the stem relative to a flow path of the valve.
